(19) United States
(12) Patent Application Publication
(10) Pub. No.: US 2001/0045258 A1
(43) Pub. Date: Nov. 29, 2001

(54) Method of reworking a transition of a decorative and protective strip of plastic material to an adjoining planar element

(76) Inventor: Patrick Ott, Konigsdorf (DE)

Correspondence Address: MARSHALL, O'TOOLE, GERSTEIN,, MURRAY & BORUN, 6300 Sears Tower, 233 South Wacker Drive, Chicago, IL, 60606-6402, US

(21) Appl. No.: 09/782,493

(22) Filed: Feb. 13, 2001

(30) Foreign Application Priority Data
Feb. 15, 2000 (DE) P10006661.5

(51) Int. Cl. B32B 31/00

(52) U.S. Cl. 156/159

(57) ABSTRACT

The invention relates to a method of reworking a transition of a decorative and protective strip of plastic material to an adjoining planar element, preferably the board of a piece of furniture. Such an improved method is intended to be executable also by machine in a continuous operation. For this purpose, most of the excess length of the decorative and protective strip of plastic material with respect to an adjoining portion of the planar element is removed by a machining operation. Subsequently, at least the machined area of the decorative and protective strip of plastic material, which includes white fracture areas, is wetted with a multi-component lubricating oil with good creeping properties, and the residual excess length is then removed by brush rolls and a smooth transition from the planar element to the decorative and protective strip of plastic material is produced by brushing.

The present invention relates to a method of reworking a transition of a decorative and protective strip of plastic material to an adjoining planar element, preferably the board of a piece of furniture.

In particular in the case of planar elements consisting of pressboard and used for pieces of furniture, e.g. a tabletop, also the lateral edges must be covered primarily against an ingress of moisture and for reasons of a pleasant outward appearance. Normally, the main surfaces of such planar elements are already provided with an outer layer that is laminated thereon. For the lateral surfaces, decorative and protective strips of plastic material are often used, said decorative and protective strips of plastic material being normally glued on. Such strips are often attached by machine in a continuous operation. In so doing, attention must be paid to the fact that the surfaces of the planar element and of the strip should, if possible, merge without any step being formed between them so that an optically perfect outward appearance will be obtained. Reworking is carried out by hand in many cases and entails, moreover, some problems. When such decorative and protective strips of plastic material are glued on, glue or adhesive often wells out at the butt joints between the surface and the strip, and this glue or adhesive has to be removed as well. In addition, when plastic material is excessively worked, especially when the colour of this material is not white, white fracture areas are formed, i.e. the cut area is brighter than the edge surface, and, up to now, it has not been possible to adapt its colour.

It is now the object of the present invention to provide a method of reworking such transitions from decorative and protective strips of plastic material to adjoining planar elements which can also be executed by machine.

For this purpose, most of the excess length of the decorative and protective strip of plastic material with respect to an adjoining portion of the planar element is removed by a machining operation (cutting operation). Subsequently, at least the machined area of the decorative and protective strip of plastic material, which includes white fracture areas, is wetted with a multi-component lubricating oil with good creeping properties, and the residual excess length is then removed by at least one brush roll and a smooth transition from the planar element to the decorative and protective strip of plastic material is produced by brushing.

It is extremely difficult to make the strip merge smoothly with the surface of the planar element at the first attempt; hence, it is preferred to leave a suitable excess length, which is then removed, e.g. cut off. The cutter can, however, only be moved down to a certain depth so as to prevent it from coming into contact with the surface of the planar element; hence, a certain residual excess length will always remain in view of this spacing tolerance that has to be observed. Especially in the case of coloured strips, the cut surface shows unattractive white fracture areas which have to be removed by all means. In order to support the removal effectively, a multi-component lubricating oil with good creeping properties is now applied so that said lubricating oil can penetrate in all the minute cracks especially in the region of the white fracture areas and wet the surface completely. This completely wetted surface of plastic material is then reworked by means of brush rolls. In the course of this process, the multi-component lubricating oil guarantees a neat and smooth removal by the brushes so that the white fracture areas will be eliminated completely. A point of importance in this respect is that the multi-component lubricating oil has sufficient wetting power.

In addition, residues of glue and/or adhesive in the case of a decorative and protective strip of plastic material glued on the planar element can be removed along with other material at least during the brush roll treatment. Without the use of the multi-component lubricating oil, such left-over residues of adhesive would smear and lead again to an unattractive surface. In this connection, it should be mentioned that specific multi-component lubricating oils with good creeping properties also have cleaning properties which facilitate the removal of the residues of glue and adhesive to a great extent.

In order to permit the multi-component lubricating oil to become fully effective, said lubricating oil can, according to an advantageous embodiment, consist essentially of a hydrocarbon mixture which is free of silicone, Teflon and/or graphite. The composition of the multi-component lubricating oil should be of such a nature that it will not attack under any circumstances plastic materials, wood materials or surfaces of the type provided especially in the case of furniture so that the effect produced is mainly an effect supporting the treatment carried out and an effect supporting the removal of residues of glue and adhesive. A multi-component lubricating oil with good creeping properties which is very suitable for these purposes additionally has further advantages and can be used especially as a lubricant, rust remover, cleaning agent and contact oil. This oil has a very low surface tension and a very high dielectric strength (U_{D}=45 KV/CM) and, due to the excellent capillary action, it penetrates into extremely fine capillary cracks and gaps. Due to these creeping properties, it will creep below and dissolve mineral as well as organic dirt so that especially residues of adhesive can be removed very easily. This lubricating oil is also able to remove powder, lead, tombac and powder residues. It will neutralize hand sweat and it will also protect aluminium, copper, brass, chromium-plated and electroplated surfaces as well as stainless steel. In particular, varnish, leather, wood, rubber, plastic materials and fabrics will not be impaired. Due to its good creeping properties, the lubricant will creep below and dissolve mineral as well as organic dirt so that spots (e.g. tar, break dust, residues of adhesive, etc.) can be removed easily. In addition, the lubricant tends to form a clear, invisible, non-curing film. Multi-component lubricating oils having an identical or a similar composition and equivalent creeping properties can also be used for this intended purpose.

According to an advantageous embodiment, the multi-component lubricating oil can be applied by an adsorbent application medium, preferably a felt. Felts having different degrees of hardness can be used for this purpose. An application by means of sponges, brushes and the like is, however, possible as well.

The wetted, remaining residual excess length must be removed as well. Hence, it will be expedient to use brush rolls which are also able to cut and remove material to a certain degree. For this purpose, the brush rolls can brush off the residual excess length mainly by means of bristles consisting of a fibre-shaped material with cutting properties. Materials which are particularly suitable for this purpose are natural products; horsehair is one of these natural products. According to a preferred variant, the bristles consist of sisal which also has advantageous cutting properties and which guarantees that the residual excess length will be removed.

In particular when the strips have been glued on and when residues of adhesive exist, the brush rolls can clog within a very short period of time so that cleaning will then be necessary. In order to prevent this, the residual excess length can be brushed off mainly by Teflon-coated bristles of the brush rolls. The tendency of Teflon-coated bristles towards clogging with these adhesives is less strong; otherwise, such clogging would impair the effect of the brushes to a great extent.

Preferably, at least two brush rolls can be arranged in series and the second brush roll can rework and polish the transition from the planar element to the decorative and protective strip of plastic material. The first brush roll will then perform the somewhat coarser removal work, whereas the subsequent brush roll will provide optically perfect smoothing and polishing so that there will be a harmonic transition from the planar element to the decorative strip.

Especially when the method in question is carried out by machine, the cutting, wetting and brushing can be carried out in a continuous operation. This can be done in one plant or also in plants which are arranged in series. The only point of importance is that reworking by hand is avoided as far as possible. Due to the use of the multi-component lubricating oil, residues of glue and adhesive are removed by cleaning to such a high degree and the outward appearance of the components dealt with is improved to such an extent that reworking by hand can be dispensed with completely.

In the case of boardlike planar elements, an upper and a lower excess length of the decorative and protective strip of plastic material can, in addition, be removed substantially simultaneously. This can actually be done in parallel or sequentially within one plant so that, e.g. also in the case of a continuous operation, both edges will be subjected to suitable reworking in one operation.

In the following, the sequence of method steps will be explained once more on the basis of a drawing, in which:

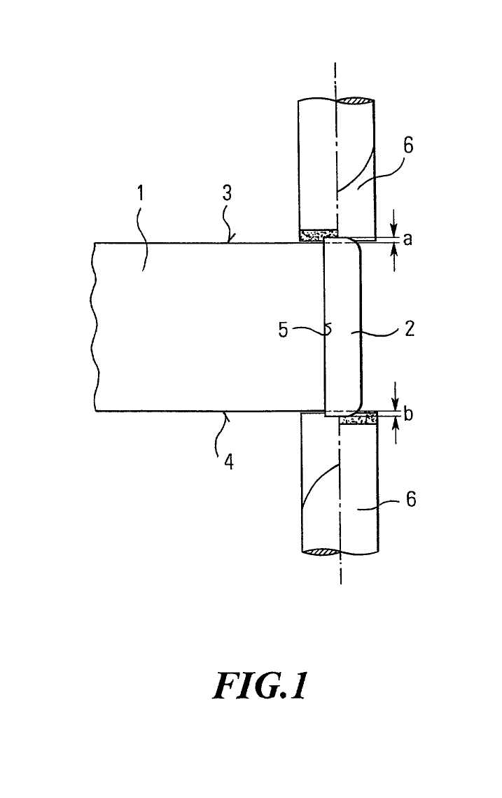

FIG. 1 shows how the excess length is cut off in the case of a tabletop provided with a strip of plastic material;

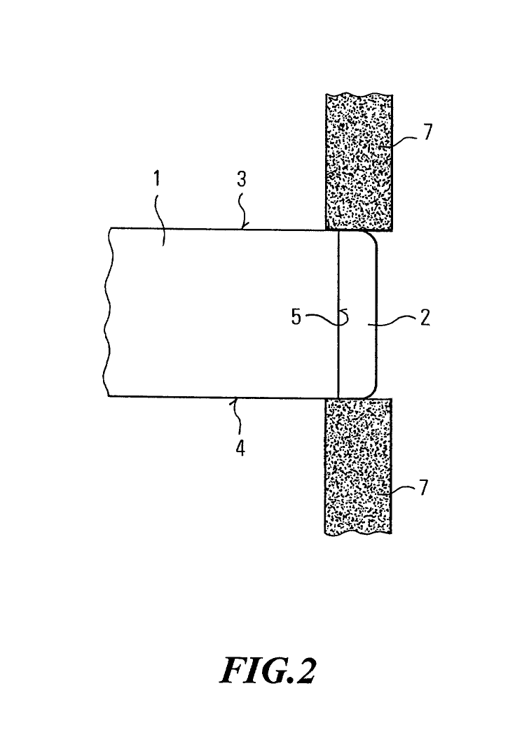

FIG. 2 shows how decorative strip sections cut according to FIG. 1 are wetted with a multi-component lubricating oil and

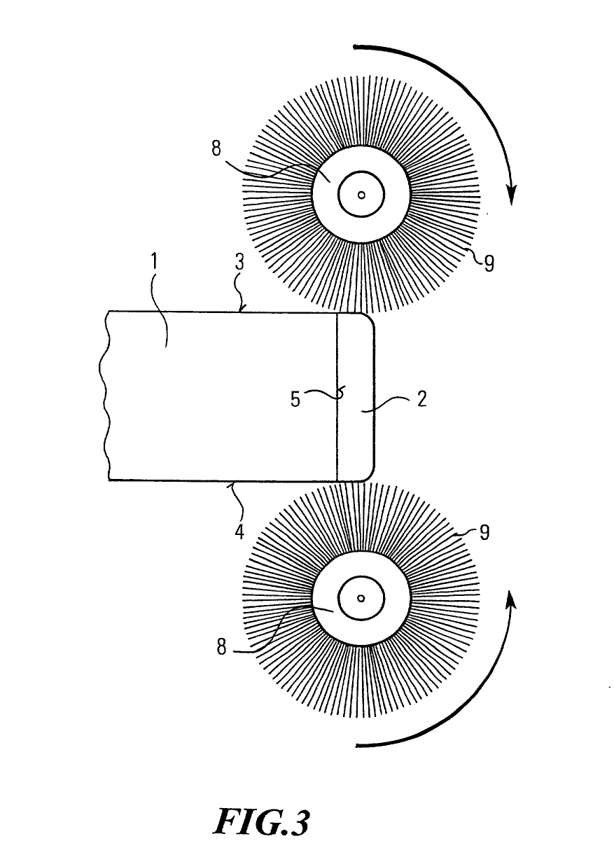

FIG. 3 shows how the sections wetted in FIG. 2 are brushed by means of brush rolls.

In FIG. 1 a tabletop 1, on the longitudinal side of which a decorative and protective strip 2 of plastic material is glued on, is worked. The tabletop consists preferably of a pressboard having layers of plastic material laminated thereon on the upper surface 3 and on the lower surface 4 thereof. The sides of the pressboard are covered by means of the glued-on decorative and protective strip 2 of plastic material, which can also be arranged such that it extends along the full circumference.

For reasons of production engineering, it will be easier to make the strip 2 project on the upper surface and on the lower surface with certain excess lengths a and b. This will guarantee that the whole lateral surface 5 of the tabletop 1 is covered by the strip 2. When the strip 2 is glued on, residues of glue and adhesive will well out, which will have to be removed as well.

The reworking of the excess lengths a and b is carried out initially by means of the step shown in FIG. 1 in which most (e.g. approx. 80 to 90%) of the excess lengths a and b is cut off by means of cutters 6. This is done on the upper and lower surfaces essentially uniformly and simultaneously. In so doing, care should be taken that the cutters 6 do not cut into the upper surface 3 or the lower surface 4 of the tabletop 1.

The excess lengths a and b are only a few tenths of a millimeter long.

After the cutting operation shown in FIG. 1, a certain residual excess length still remains, which has to be removed as well. Especially in the case of coloured strips 2, an additional problem arises in that white fracture areas exist at the cut surface, said white fracture areas resulting in an unattractive outward appearance. In preparation of a further removal, a multi-component lubricating oil with good creeping properties is therefore applied by means of an application element 7, which consists preferably of felt, according to the step shown in FIG. 2. The lubricating oil wets at least the cut surface, but it also reaches the neighbouring areas. In particular, the locations to which residues of adhesive still adhere should be wetted as well. The good creeping properties of the oil guarantee that the oil will penetrate into each very fine capillary crack, especially in the region of the white fracture areas, and that it will also penetrate below the residues of adhesive so that a subsequent removal will be facilitated substantially.

Felts 7 of different thicknesses and strengths may be used, provided that their absorbency suffices for the intended use. The felts 7 may be simple strips or rollers which slide along or roll on the strip surface. It is also possible to press the felts 7 (irrespectively of their shape) onto the edge area with a predetermined force (e.g. by means of a spring) so that a defined contact exists. In addition, the felt can be adapted to this edge area or it can be provided with a profile so that it can be pressed onto said edge area optimally. For this purpose, it may be composed of several parts and it may be pressed onto the edge at an oblique angle so as to achieve symmetrical pressure forces. The same applies to the structural design of felt rollers.

An oil which is suitable to be used as a multi-component lubricating oil is especially an oil having the properties described hereinbefore. However, similar substances which produce equivalent effects should be used as well. The flash point of the known lubricating oil is 78° C. and it contains neither silicone nor graphite nor Teflon and is therefore primarily based on hydrocarbon. In addition, it behaves neutrally with respect to varnish surfaces, leather, synthetic material, wood, rubber and plastics. In particular, it is also capable of dissolving residues of adhesive.

Finally, the transition areas between the strip 2 and the tabletop 1 are worked by brush rolls 8. While the tabletop 1 is moving at right angles to the plane of the drawing relative to the brush rolls 8, said brush rolls rotate clockwise or anticlockwise depending on the respective edge associated therewith. Depending on the basic material or tabletop material to be worked, different materials are used for the bristles 9. Also the setting angles of the brush rolls 8 relative to the edge to be worked are only shown by way of example in FIG. 3. The brush rolls 8 may, for example, also be positioned precisely at right angles to the outer surface of the strip. An oblique setting angle is possible as well. In the case of a wood surface, it may perhaps be necessary to take the grain direction into account during the brushing operation. For this purpose, suitable speeds, directions of rotation, relative setting angles (positioning of the axis of rotation relative to the tabletop 1 and the strip 2) are used so as to achieve different effects and so as to deal with different combinations of materials.

In addition, a plurality of brush rolls 8 may be arranged in series, and these brush rolls may perhaps be equipped with different bristles 9. Preferably, coarse machining with a suitable removal of material is carried out first. For this purpose, the bristles 9 may consist of sisal which has still a certain degree of cutting or scraping properties. In order to prevent the residues of adhesive from collecting between the bristles 9, said bristles may be coated with Teflon so that the residues of adhesive cannot adhere easily. A subsequent brush roll 8 can then be provided with softer bristles 9 for reworking or polishing operations. This brush roll may then also have a different speed, direction of rotation and setting angle.

The multi-component lubricating oil used guarantees in the brushing operation shown in FIG. 3 a neat, smear-free removal in the course of which the white fracture areas and the residues of adhesive are eliminated.

It goes without saying that the method steps shown in FIGS. 1 to 3 can be performed in a continuous operation so that the reworking of decorative and protective strips of plastic material for achieving a neat transition to the adjoining tabletop 1 can be carried out by machine.

1. A method of reworking a transition of a decorative and protective strip of plastic material (2) to an adjoining planar element (1), preferably the board of a piece of furniture, wherein most of the excess length (a, b) of the decorative and protective strip of plastic material (2) with respect to an adjoining portion of the planar element (1) is removed by a machining operation, at least the machined area of the decorative and protective strip of plastic material (2), which includes white fracture areas, is wetted with a multi-component lubricating oil with good creeping properties, and the residual excess length is then removed by brush rolls and a smooth transition from the planar element (1) to the decorative and protective strip of plastic material (2) is produced by brushing.

2. A method according to claim 1, characterized in that, in the case of a decorative and protective strip of plastic material (2) glued on the planar element (1), residues of glue and/or adhesive are removed along with other material at least during the brush roll treatment.

3. A method according to claim 1 or 2, characterized in that the multi-component lubricating oil consists essentially of a hydrocarbon mixture which is free of silicone, Teflon and/or graphite.

4. A method according to one of the claims 1 to 3, characterized in that the multi-component lubricating oil is applied by an absorbent application medium (7), preferably a felt.

5. A method according to one of the claims 1 to 4, characterized in that the brush rolls (8) brush off the residual excess length mainly by means of bristles (9) consisting of a fibre-shaped material with cutting properties.

6. A method according to claim 5, characterized in that the bristles (9) consist of sisal.

7. A method according to one of the claims 1 to 6, characterized in that the residual excess length is brushed off mainly by Teflon-coated bristles (9) of the brush rolls (8).

8. A method according to one of the claims 1 to 7, characterized in that at least two brush rolls (8) are arranged in series and that the second brush roll (8) reworks and polishes the transition from the planar element (1) to the decorative and protective strip of plastic material (2).

9. A method according to one of the claims 1 to 8, characterized in that the cutting, wetting and brushing are carried out in a continuous operation.

10. A method according to one of the claims 1 to 9, characterized in that, in the case of boardlike planar elements (1), an upper (a) and a lower (b) excess length of the decorative and protective strip of plastic material (2) are removed substantially simultaneously.
